(19) United States
(12) Patent Application Publication
(10) Pub. No.: US 2018/0076551 A1
(43) Pub. Date: Mar. 15, 2018

(54) MULTIPOLE CONNECTOR, CONNECTOR DEVICE, CASE, AND METHOD FOR CONNECTING CABLE TO MULTIPOLE CONNECTOR

(71) Applicant: Mitsubishi Electric Corporation, Chiyoda-ku (JP)

(72) Inventors: Tetsuhiro MATSUYAMA, Tokyo (JP); Miwako KOSAKA, Tokyo (JP); Katsuya HARADA, Tokyo (JP); Keitaro YAMAGISHI, Tokyo (JP); Yuichi SASAKI, Tokyo (JP)

(73) Assignee: Mitsubishi Electric Corporation, Chiyoda-ku (JP)

(21) Appl. No.: 15/560,045

(22) PCT Filed: Apr. 14, 2015
(86) PCT No.: PCT/JP2015/061502

§ 371 Date: Sep. 20, 2017

(51) Int. Cl. H01R 12/77; H01R 12/70; H01R 13/6585; H01R 13/6592

(52) U.S. Cl. CPC H01R 12/775; H01R 12/707; H01R 13/6463; H01R 13/6592; H01R 13/6585

(57) ABSTRACT

A multipole connector includes a connector body that includes a first end surface and a second end surface; a plurality of contacts that are arranged and led to the first end surface of the connector body; and a ground plate. The multipole connector is connected to a cable in which ground meshes forming external conductors that are to be grounds and core wires that are to be signal lines are insulated from each other by an inner jacket and the outer side is sheathed with an outer jacket. The signal lines are connected to signal line contacts in the contacts, respectively, the ground meshes are connected together on the ground plate, and the ground plate is connected to at least one of the ground contacts of the contacts.

### FIELD

The present invention relates to a multipole connector, a connector device, a case, and a method for connecting a cable to the multipole connector, and particularly to a structure of the connection between a cable and a connector.

### BACKGROUND

A conventional shielded cable connecting method has been disclosed In which a plurality of coaxial cables are connected to a multipole connector, such as a D-SUB (D-subminiature) and a micro D-SUB, while maintaining noise immunity. The D-SUB and the micro-D-SUB are some of the widespread connector standards and are widely used mainly for connecting computers and peripheral devices to each other. The D-SUB and the micro D-SUB are configured to have two to four rows of pin contacts or socket contacts that are surrounded by a metal shield having a shape resembling the letter “D”.

Patent Literature 1 discloses an example of a method of connecting, to a connection target circuit, internal conductors and external conductors of a plurality of coaxial cables connected to a connector. In Patent Literature 1, a technology is disclosed in which the side portion of a ground plate is pressed against one side of a base insulator such that it is deformed, thereby bringing a plurality of ground contacts into pressure-contact with the ground plate.

Moreover, in Patent Literature 2, there is a disclosure of a technology for connecting shielded wires to a multipole connector. The structure disclosed in Patent Literature 2 is configured such that wires are first crimped to the contacts of the connector and then the connector is inserted into a connector housing.

Furthermore, Non Patent Literature 1 discloses a cable-end shield connecting technology. In Non Patent Literature 1, the ends of the cables are stripped of their outer jackets and the grounding wire is connected to the exposed shielding braids by soldering.

### CITATION LIST

### Patent Literature

Patent Literature 1: Japanese Patent No. 3333936

Patent Literature 2: Japanese Patent No. 3111655

### Non Patent Literature

Non Patent Literature 1: JERG-0-041A Electric Wiring Process Standards for Space Applications

### SUMMARY

### Technical Problem

However, with the structure in Patent Literature 1, the ground plate is interposed and held between the ground contacts and the insulator; therefore, a slight misalignment may cause poor contact. Moreover, this structure cannot provide sufficient shielding properties and has low noise immunity.

The structure in Patent Literature 2 is configured such that wires are crimped to the contacts and then the contacts are inserted into the connector housing, but this structure inhibits size reduction. Moreover, because the contacts of the multipole connector are of a particular shape, the contacts need to be highly accurately molded.

Furthermore, with the structure in Non Patent Literature 1, it is necessary to solder the external conductors one by one; therefore, this structure reduces the ease of manufacturing and inhibits size reduction. Moreover, this structure cannot provide sufficient shielding properties and has low noise immunity.

As described above, with the above conventional technologies, not only are shielding properties insufficient but it is difficult to reduce the size of the connection portion.

The present invention has been achieved in view of the above and an object of the present invention is to provide a multipole connector that is compact and has a simple structure.

### Solution to Problem

In order to solve the above problems and achieve the object, an aspect of the present invention is a multipole connector including a connector body that includes a first end surface and a second end surface; a plurality of contacts that are arranged and led to the first end surface of the connector body; and a ground plate. The multipole connector is connected to a cable in which external conductors that are to be grounds and core wires that are to be signal lines are insulated from each other by an inner jacket and the outer side is sheathed with an outer jacket. The signal lines are connected to the contacts, respectively, the shield wires are connected together on the ground plate, and the ground plate is connected to at least one of the contacts

### Advantageous Effects of Invention

According to the present invention, an effect is obtained where it is possible to obtain a multipole connector that can have a simple structure and can be reduced in size.

### BRIEF DESCRIPTION OF DRAWINGS

FIG. 1 is a perspective view illustrating a connector device according to a first embodiment.

FIG. 2 is a top view illustrating the connector device according to the first embodiment.

FIG. 3 is a side view with partial cutaway of the connector device according to the first embodiment.

FIG. 4 is a cross-sectional view of a coaxial cable that is used in the connector device according to the first embodiment, and is a cross-sectional view taken along line A-A in FIG. 2.

FIG. 5 is a cross-sectional view of the coaxial cable that is used in the connector device according to the first embodiment, and is a cross-sectional view taken along line B-B in FIG. 3.

FIG. 6 is an exploded perspective view of the connector device according to the first embodiment.

FIG. 7 is a perspective view of a multipole connector of the connector device according to the first embodiment.

FIG. 8 is a perspective view illustrating an assembling process of the connector device according to the first embodiment, where (a) is a perspective view with partial cutaway of the whole connector device and (b) is an enlarged perspective view of a relevant portion in

FIG. 9 is a perspective view illustrating an assembling process of the connector device according to the first embodiment.

FIG. 10 is a perspective view illustrating an assembling process of the connector device according to the first embodiment.

FIG. 11 is a perspective view illustrating a connector device according to a second embodiment.

FIG. 12 is a top view illustrating the connector device according to the second embodiment.

FIG. 13 is a side view with partial cutaway of the connector device according to the second embodiment and is a diagram illustrating a portion taken along line C-C in FIG. 11.

FIG. 14 is a top view illustrating a modification of the connector device according to the second embodiment.

FIG. 15 is a side view with partial cutaway of the connector device according to the second embodiment.

FIG. 16 is a cross-sectional view illustrating a shielded twisted cable that is used in a connector device according to a third embodiment.

FIG. 17 is an explanatory diagram of the inside of a connector device according to the third embodiment.

FIG. 18 is an explanatory diagram of the inside of a connector device according to a fourth embodiment.

FIG. 19 is an explanatory diagram of a ground plate of the connector device according to the fourth embodiment.

FIG. 20 is an explanatory cross-sectional view illustrating a modification of the connector device according to the fourth embodiment.

FIG. 21 is an explanatory diagram inside of a connector device according to a fifth embodiment.

FIG. 22 is an explanatory cross-sectional view of the connector device according to the fifth embodiment and corresponds to a cross section taken along line E-E in FIG. 21.

FIG. 23 is an explanatory cross-sectional view of the connector device according to the fifth embodiment and corresponds to a cross section taken along line F-F in FIG. 21.

FIG. 24 is an explanatory diagram of the inside of a connector device according to a sixth embodiment.

FIG. 25 is an explanatory cross-sectional view of the connector device according to the sixth embodiment and corresponds to a cross section taken along line G-G in FIG. 24.

### DESCRIPTION OF EMBODIMENTS

A multipole connector, a case that forms a back shell, a connector device, and a method for connecting a cable to the multipole connector according to embodiments of the present invention will be described below in detail with reference to the drawings. This invention is not limited to these embodiments.

### First Embodiment

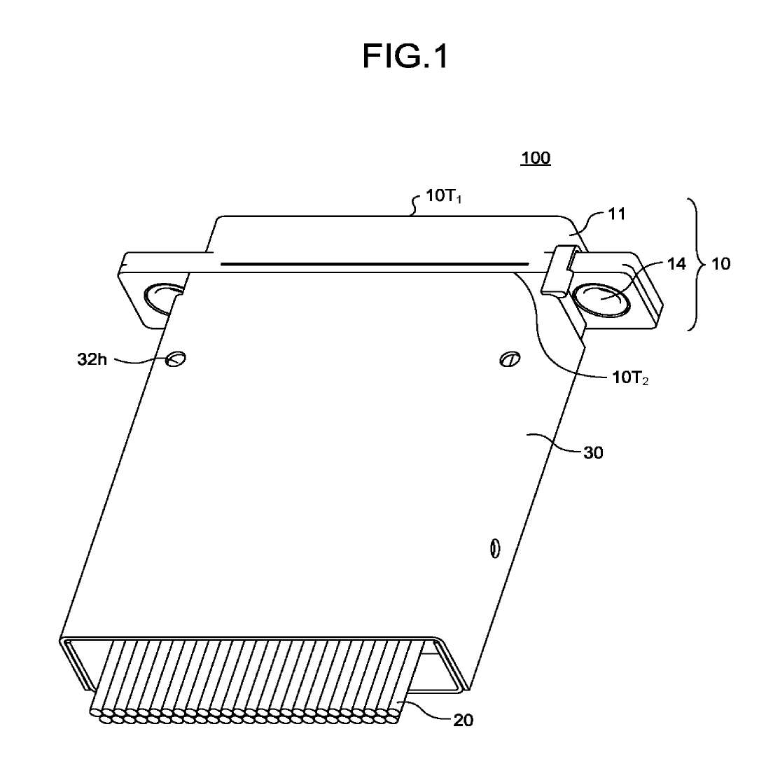

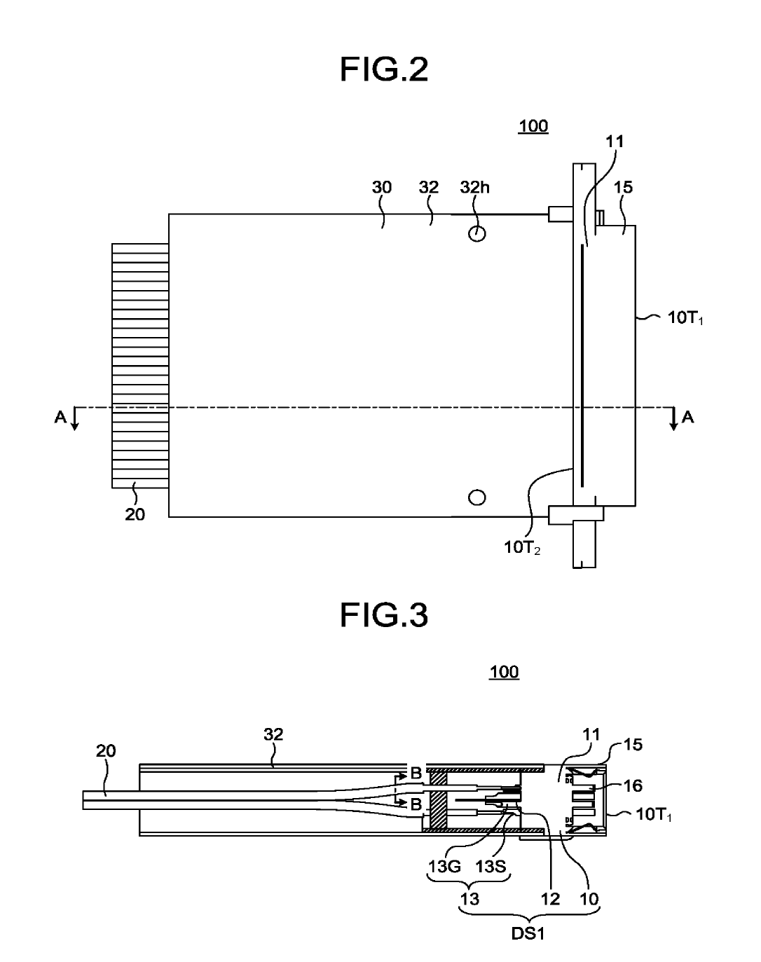

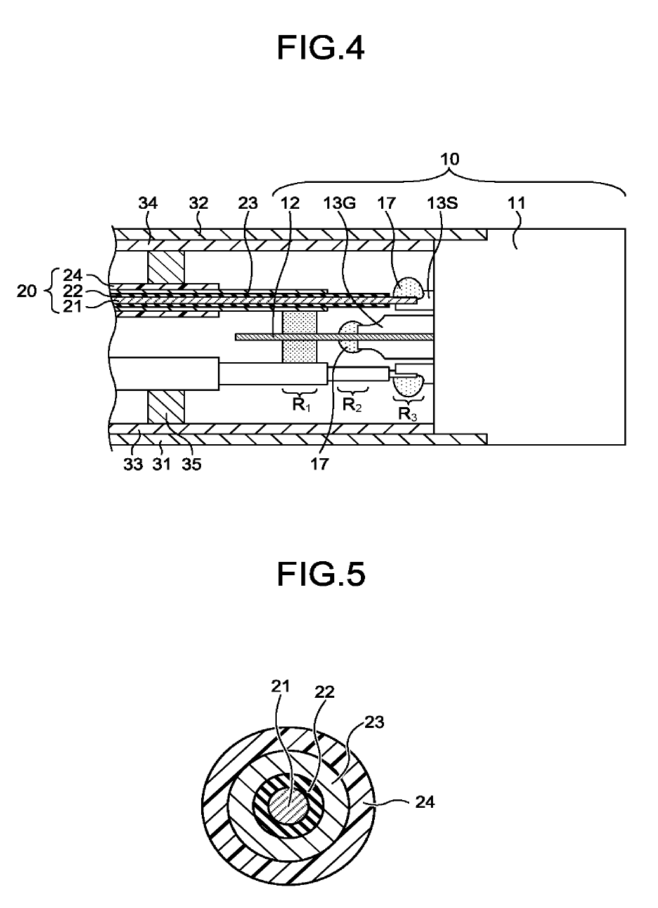

FIG. 1 is a perspective view illustrating a connector device according to a first embodiment of the present invention. FIG. 2 is a top view illustrating the connector device according to the first embodiment; FIG. 3 is a side view with partial cutaway of the connector device according to the first embodiment; and FIG. 4 and FIG. 5 are cross-sectional views of a coaxial cable and are respectively cross-sectional views taken along line A-A in FIG. 2 and line B-B in FIG. 3. A connector device 100 in the first embodiment includes a connector body 10, which has a firs end surface 10T₁ and a second end surface 10T₂, which face in opposite directions from each other; a plurality of cables 20 connected to the connector body 10; and a case 30, which has a back shell structure and houses a connection region where the connector body 10 and the cables 20 are connected to each other. In the connector device in the first embodiment, the external conductors of the coaxial cables 20 that are to be grounds are first connected together by soldering them to a ground plate 12 so as to connect them to ground contacts 13G extending from the second end surface 10T₂ of the connector body 10, and the core wires that are to be signal lines are connected to signal line contacts 13S, thereby enabling the aligned cables 20 to be drawn out, as the ground contacts 13G and the signal line contacts 13S, to the first end surface 10T₁ of the connector body 10. The solder-connected portions are housed in the metal case having a shielding function. Consequently, a compact connector device having a back shell structure is obtained that has both a shielding function for ensuring noise immunity and a back shell function for ensuring mechanical strength as well as having an excellent ENC performance.

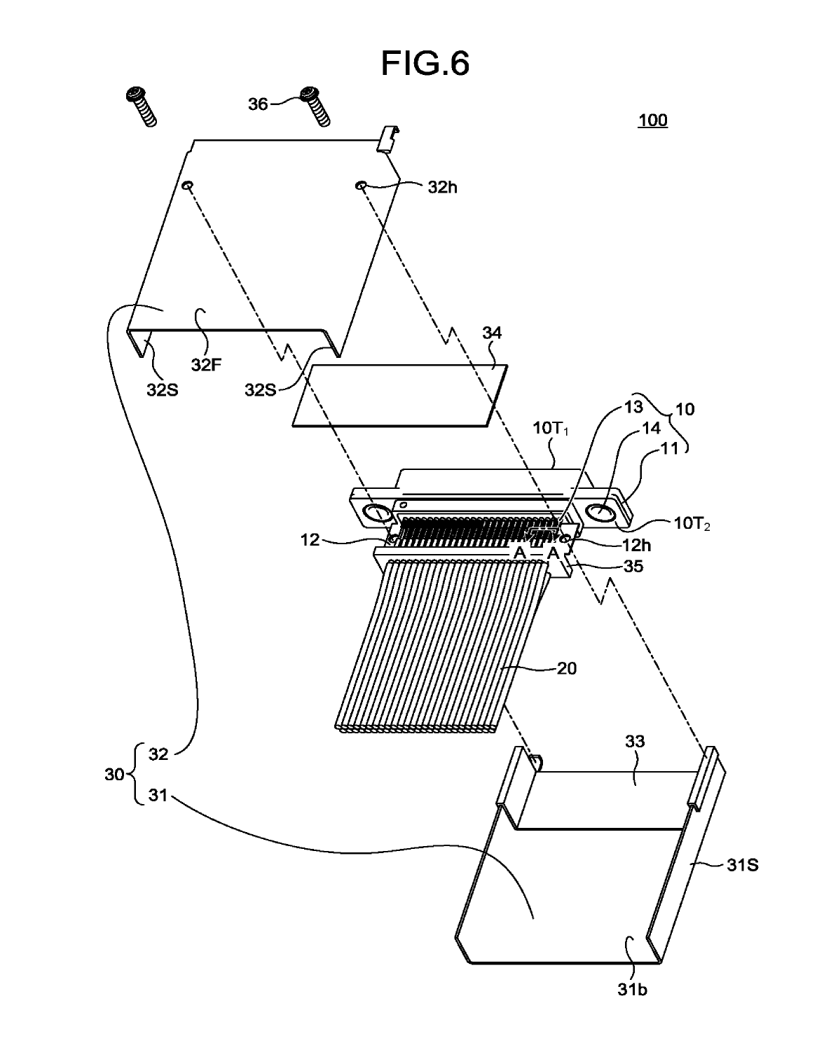

As illustrated in FIG. 3, a multipole connector DS1 includes the connector body 10, the ground plate 12 made from a copper plate, and a plurality of contacts 13. As illustrated in the overall view in FIG. 1, the connector device includes the cables 20, the case 30, and the multipole connector, which includes the connector body 10 and the ground plate 12. As illustrated in the enlarged cross-sectional view of a relevant portion of the connection portion of the cable 20 and the connector body 10 in FIG. 4, the connector body 10 includes a base 11, which is a molded resin body covered with a metal plate; and the contacts 13 extending from the base 11. The contacts 13 are embedded in the molded resin body of the base 11 and are provided in four rows. The other ends of the contacts 13 form external contacts 16. The contacts 13 include the signal line contacts 13S, which are to be connected to signal lines, and the ground contacts 13G, which are to e connected to the grounds. The external contacts 16 are connected to a contact of a receptacle or a plug that is a connection partner (not illustrated). Although the external contacts 16 are not illustrated in FIG. 4, the external contacts 16 extend to the first end surface 10T₁ side of the connector body 10 and are used as external connection terminals, as illustrated in FIG. 3. During the assembling process illustrated in FIG. 6, the ground plate 12 is held and secured within the case 30 but is not directly secured to the case 30. The connector body 10 has a pair of mounting holes 14 on both sides of the base 11. The connector device can, for example, be attached and secured to the wall by inserting screws into the mounting holes 14. The first end surface 10T₁ side of the connector body 10 forms a terminal tube 15, in which the external contacts 16 are formed.

As illustrated in FIG. 1, the cables 20 are arranged in two rows. FIG. 4 is an enlarged cross-sectional view that includes the connection portion of one of the cables 20 and the connector body 10, and FIG. 5 is an enlarged cross-sectional view of the cable 20. As illustrated in FIG. 4 and FIG. 5, the cable 20 is a coaxial cable, in which a core wire 21, which functions as a signal line, is sheathed with an inner jacket 22, which is in turn sheathed with a ground mesh 23 made of a metal mesh, with the ground mesh 23 being in turn sheathed with an outer jacket 24. The ground mesh 23 is made by weaving copper wires into a mesh and is known as a braided wire. Alternatively, the ground mesh 23 with its surface coated with solder may be used.

In the connection portion of the connector body 10 and the cable 20, the cable 20 is stripped of its outer jacket 24 in order to make an electrical connection. First, in a first region R₁, in which the cable 20 is to be connected to the ground plate 12, the outer jacket 24 is stripped and thus the ground mesh 23 is exposed. The cable 20 is connected to the ground plate 12 by a solder layer 17 in the first region R₁. With this connection, because the ground mesh 23 of the cable 20 is connected to the ground plate 12 by the solder layer 17, the potentials of the cable 20 and the ground plate 12 become equal. Then, on a portion of the ground plate 12 corresponding to a second region R₂, the ground contact 13G in the contact 13 is connected to the ground plate 12 by the solder layer 17 at a position at which the ground contact 13G faces the ground mesh 23 of the cable 20, and thus the ground mesh 23 and the (ground contact 13G are electrically connected via the ground plate 12. The ground contacts 13G form the external contacts 16, which are external connection terminals in the second and third rows, as illustrated in FIG. 3. Further, a third region R₃ is formed, which is closer to the connector body 10 than the second region R₂ and in which the inner jacket 22 is stripped and thus the core wire 21 is exposed. In the third region R₃, the signal line contact 13S of the connector body 10 and the core wire 21 are connected by the solder layer 17. The signal line contact 13S includes a dished recess at the tip thereof and the core wire 21 is placed in the recess and is secured by the solder layer 17.

As illustrated in the exploded perspective view of the connector device in FIG. 6, the case 30 includes a case body 31 formed from a plate-like body made of stainless steel; and a case lid 32, which fits the case body 31. The case body 31 includes a bottom plate 31b and two side plates 31S erected on both sides of the bottom plate 31b. The case lid 32 includes a lid plate 32F and two lid side plates 32S erected on both sides of the lid plate 32F. In a state where the connection portions of the connector body 10 and the cables 20 are housed in the case body 31, the two lid side plates 32S of the lid plate 325 are fitted externally to the two side plates 31S of the case body 31. These connection portions are secured to the case 30 via an electromagnetic interference prevention member 33, which is secured to part of the case body 31 and is made of, for example, an elastic conductive mesh, and an electromagnetic interference prevention member 34, which covers the case lid 32 side of the connection portions. Moreover, an electromagnetic interference prevention member 35 is provided on the outer side of the first region R₁, the second region R₂, and the third region R₃, which are the connection portions that are on the second end surface 10T₂ side of the connector body 10. The electromagnetic interference prevention member 35 allows the cables 20 to pass therethrough but seals the gap between the cables 20 and the case 30. The ground plate 12 is not secured to the case body 31 but is secured in place by inserting screws 36, which are long enough to pass through the case body 31 and the case lid 32, into mounting holes 32h provided at both ends of the case body 31 and the case lid 32.

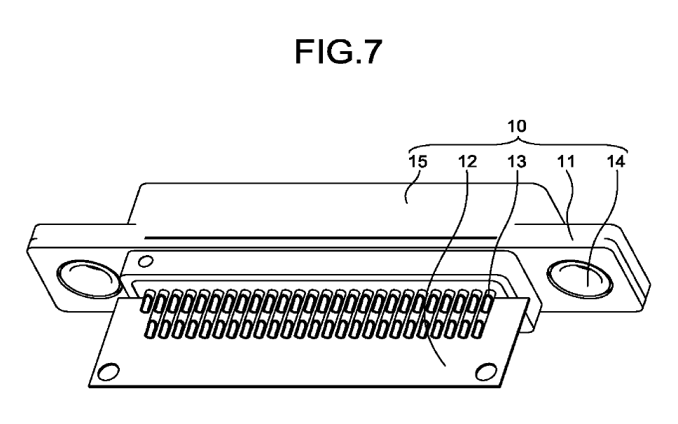

Next, a description will be given of a method for manufacturing the connector device 100, which includes a method for connecting the cables 20 to the connector body 10 that forms the multiple connector. FIG. 7 to FIG. 10 are diagrams illustrating a method for manufacturing the connector device 100. This method includes a process of forming tine connection portions by first stripping the outer jackets 24 and the inner jackets 22 of the cables 20, by positioning the cables 20 such that the first region R₁, in which the ground meshes 23, which are external conductors to be grounds, are exposed, is located over the ground plate 2, the second region R₂, which corresponds to the tips of the ground contacts G of the contacts 13, faces the first region R₁ on the ground plate 12, and the third region R₃, which correspond to the tips of the signal line contacts 13S of the contacts 13, is in contact with the core wires 21, which are signal lines, and by soldering the cables to the multiple connector at the same time; and a process of securing the cables 20 such that the connection portions are covered with the case body 31, the case lid 32, and the electromagnetic interference prevention members 33, 34, and 35, which are arranged inside the case body 31 and the case lid 32

First, as illustrated in FIG. 7, to configure the multipole connector, the connector body 10 is prepared, which includes the base 11, which is a molded resin body coated with metal; the ground plate 12 made from a copper plate; and the contacts 13 extending from the base 11. Although FIG. 7 illustrates only two rows of contacts 13, i.e., the signal line contacts 13S and the ground contacts 13G, in reality, two rows of contacts are arranged in a similar manner under the two of contacts illustrated in FIG. 7, i.e., the contacts 13 are actually arranged in four rows. The connector body 10 is obtained by injecting resin into a mold in which a lead frame including the contacts 13 and the external contacts 16, such as contact pins, is placed. The contacts 13 are embedded in the base 11 and are provided in four rows. The other ends of the contacts 13 form the external contacts 16. Although the external contacts 16 are not illustrated in FIG. 7, the external contacts 16 extend to the first end surface 10T₁ side of the connector body 10 and are used as external connection terminals, as illustrated in FIG. 3. The ground contacts 13G connected to the contact pins of the grounds are in contact with the ground plate 12 and are connected thereto by the solder layers 17.

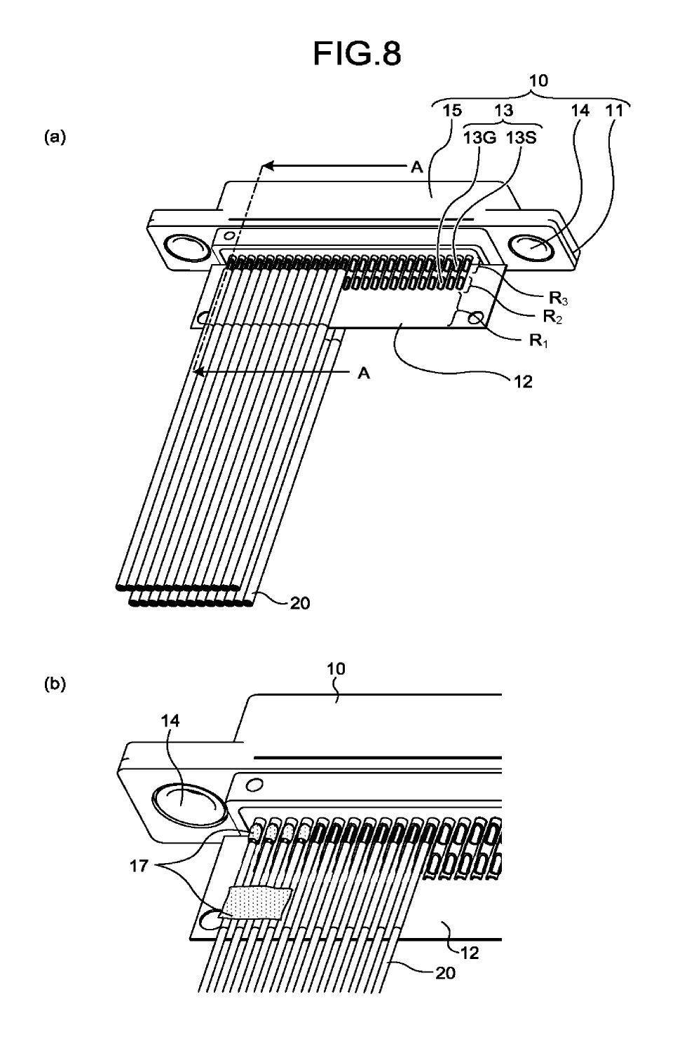

Next, as illustrated in FIG. 8(a) and FIG. 8(b), the ground contacts 13G are connected to the ground plate 12 and the ground meshes 23 are connected to the ground plate 12. Then, the signal line contacts 133 are connected to the core wires 21. At this point in time, as illustrated in FIG. 8(a), the cables 20 with the outer jackets 24 and the inner jackets 22 stripped are arranged and soldered to the ground plate 12 and the contacts 13 of the connector body 10 such that the connection portions match in each of the first region R₁, the second region R₂, and the third region R₂. FIG. 8(a) is a perspective view with partial cutaway of the whole connector device and FIG. 8(b) is an enlarged perspective view of a relevant portion in FIG. 8(a). Details are described with reference to FIG. 4 and FIG. 8(b). First, in the first region R₁, in which the cables 20 are to be connected to the ground plate 12, the outer jackets 24 are stripped and thus the ground meshes 23 are exposed, and the ground meshes 23 are connected to the ground plate 12 by the solder layer 17. With this connection, the ground meshes 23 of the cables 20 on the lower layer side are also connected to the ground plate 12. Then, on a portion of the ground plate 12 corresponding to the second region R₂, the ground contacts 13G in the contacts 13 are connected to the ground plate 12 by the solder layers 17 at positions at which the ground contacts 13G face the ground meshes 23 of the cables 20, and thus the ground meshes 23 and the ground contacts 13G are electrically connected via the ground plate 12.

Moreover, in the third region R₃, which is closer to the connector body 10 than the second region R₂ and in which the inner jackets 22 are stripped and thus the core wires 21 are exposed, the signal line contacts 13S are connected to the core wires 21, which are signal lines, by the solder layers 17. The connections in these three regions may be made at the same time by heating a member that has been plated with solder or may be made by heating each connection portion while feeding solder to each connection portion. In such a manner, the connections are made in the first region R₁, the second region R₂, and the third region R₃ by using the solder layers 17.

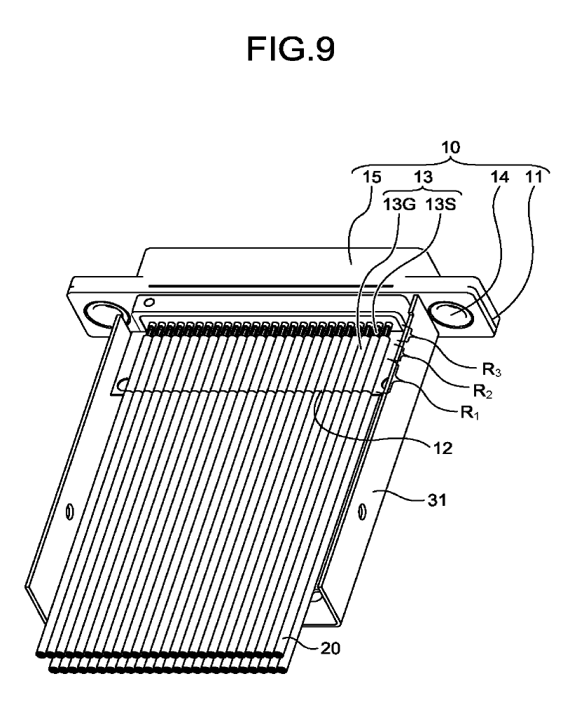

Thereafter, as illustrated in FIG. 9, the connector body 10 to which the cables 20 are connected is attached to the case body 31 such that the ground plate 12 is placed on the case body 31 with the electromagnetic interference prevention member 33 therebetween.

Then, as illustrated in FIG. 10, the case lid 32 is fitted and attached to the case body 31 so that the cables 20 that pass through the electromagnetic interference prevention member 35 are constrained, thereby securing the cables 20 in the case 30. As is apparent from the exploded perspective view in FIG. 6, the connection with the case 30 is made by interposing, between the case body 31 and the case lid 32, the structure in which the cables 20 and the connector body 10 are connected, and then tightening the screws 36 that have passed through mounting holes 12h provided at both ends of the ground plate 12 and the mounting holes 32h of the case body 31 and the case lid 32.

In the connector device 100 configured in such a manner, the ground meshes 23 of the cables 20 are soldered to the ground plate 12, which is integrated with the ground pins of a micro D-SUB; therefore, the connector device 100 is simple in structure and is easy to manufacture. Moreover, the cables 20 can be connected in the connection region that includes the first region R₁, the second region R₂, and the third region R₃ without compromising the structure of the coaxial cables. In other words, the connection can be made while maintaining a constant distance between the signal lines that are core wires and the grounds that are external conductors. Consequently, transmission characteristics that have no distortion can be obtained.

Moreover, the length of the connection region described above can be reduced to approximately one tenth of that in the case when the connection is made by using the connection method described in Non Patent Literature 1. Thus, the connector device can be reduced in size. Because the connection portions of the connector body 10 and the cables 20 are housed in the case, the connection can be made at low cost and with high EMC performance.

For example, the structure disclosed in Patent Literature 1 has a communication performance of approximately several tens of bits per second (Mbps), whereas the connector device in the first embodiment can have a communication performance of approximately a few gigabits per second (Gbps).

Moreover, during the attaching process, cables are easily connected by soldering by collectively performing a thermal treatment after positioning; therefore, the attaching process is extremely easy.

As described above, the connector device according to the present embodiment has the following characteristics.
(1) The wiring connection portions of the connector body 10 and the cables 20 are covered with the case 30 made of a conductor, such as a metal case, so as to implement both a function as a shield case and a back shell function for ensuring mechanical strength.
(2) With the case 30 described above, no external load is applied to the soldered portions.
(3) As the structure in which a metal plate is soldered to the micro D-SUB contacts in the second and third rows that are assigned as the grounds among the four rows of the micro D-SUB contacts, a common ground plate 12 is provided.
(4) The ground plate 12 described above is fastened, with the screws 36, to the case 30, which includes the metal case body 31 and the metal case lid 32, and thus has a structure that ensures electrical continuity also with the case 30.
(5) The ground meshes 23, which are external conductors of the cables 20 that are coaxial cables, are soldered to the ground plate described above. Moreover, the core wires 21 are soldered to the signal line contacts 13S in the first and fourth rows of the micro D-SUB. Consequently, it is possible to keep the coupling state of the signal lines, which are the coaxial core wires 21, and the grounds, which include the ground meshes 23, as far as the connection portion of the external contacts 16 and an external device; therefore, noise immunity can be ensured.
(6) The second end surface 10T₂ side of the cables 20 that are coaxial cables is sealed by the electromagnetic interference prevention member 35 provided in the case 30, and the outer side of the electromagnetic interference prevention member 35 is held by bringing the outer conductor composed of e electromagnetic interference prevention members 33 and 34 into contact with the case 30. This improves the shielding function.

In the first embodiment, coaxial cables are used as the cables 20; however, the first embodiment can also be applied to multicore cables, such as pair cables and twisted-pair cables, in addition to coaxial cables. The multipole connector is not limited to a micro D-SUB and it is obvious that the first embodiment can also be applied to a D-SUB or other multipole connectors.

Moreover, the case body 31 is made of a stainless steel plate; however, other materials, such as metal or resin subjected to a process to make it function as an electrical conductor, can also be used.

Furthermore, in the first embodiment, during the assembling process illustrated in FIG. 6, the ground plate 12 is held and secured within the case 30 but is not directly secured to the case 30; however, the ground plate 12 may be secured to the case 30. The shape of the ground plate 12 can also be changed as appropriate.

Moreover, although the electromagnetic interference prevention members 33, 34, and 35 are effective at improving the EMC performance, it is not necessary to always provide all the electromagnetic interference prevention members 33, 34, and 35. If it is not necessary to have an electromagnetic interference prevention function at a position where an electromagnetic interference prevention member is provided, the electromagnetic interference prevention member may be omitted. Furthermore, it is more effective if the electromagnetic interference prevention member 33, 34, and 35 are arranged at positions as close as possible to the connection region in which the cables 20 and the contacts 13 of the connector body 10 are connected to each other.

### Second Embodiment

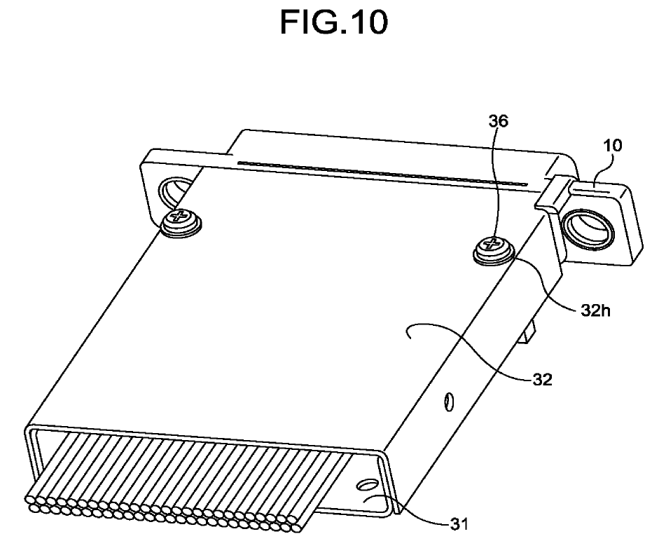

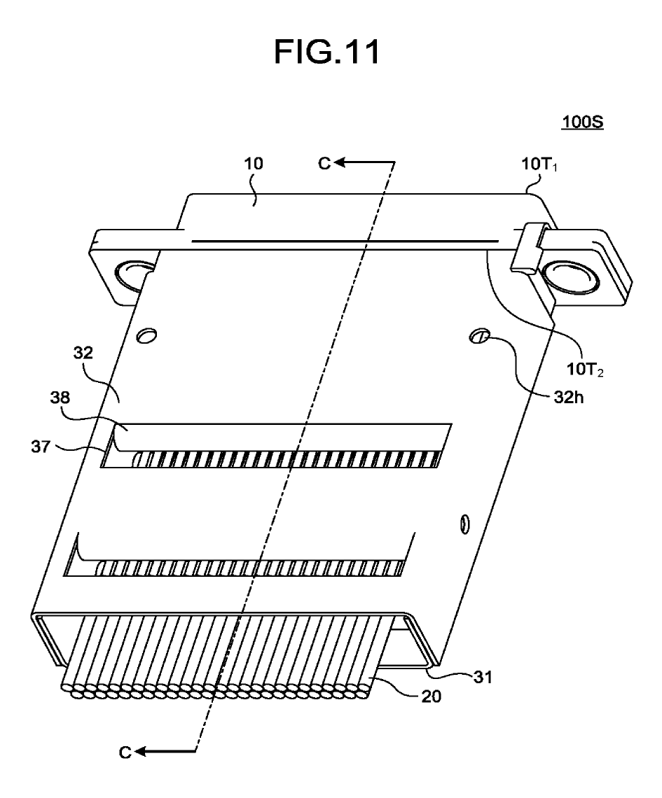

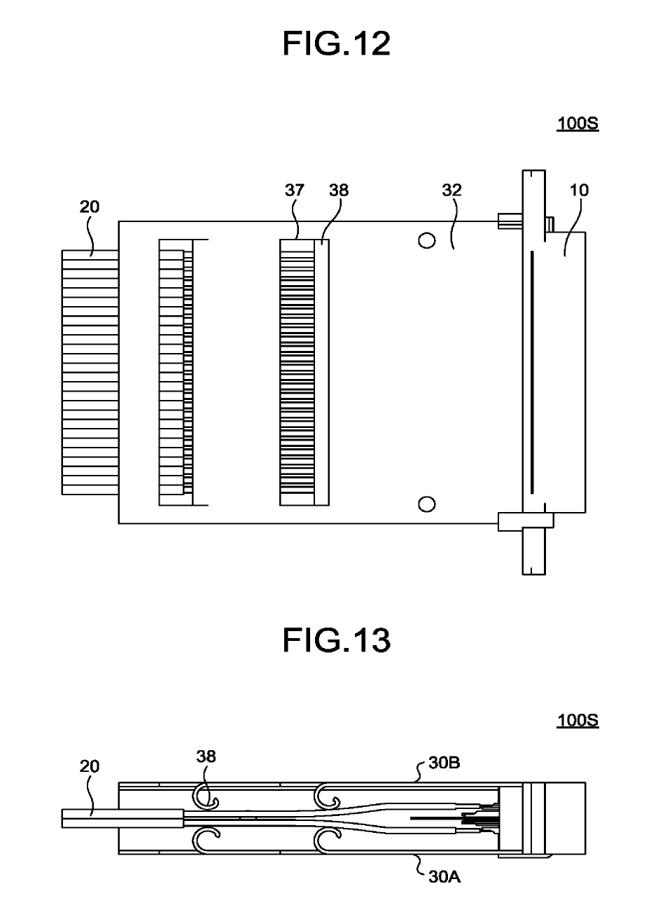

FIG. 11 is a perspective view illustrating a connector device according to a second embodiment of the present invention. FIG. 12 is a top view illustrating the connector device according to the second embodiment; and FIG. 13 is a side view with partial cutaway of the connector device according to the second embodiment and is a diagram illustrating a portion taken along line C-C in FIG. 11.

A connector device 100S in the second embodiment is different from the first embodiment in that the case body 31 and the case lid 32 are each made of an elastic leaf spring and they are each provided with two lanced pieces 38, which are cut and raised inward from notches 37 formed in a corresponding one of the case body 31 and the case lid 32. The lanced pieces 38 press against the cables 20 from first and second main surfaces 30A and 30B of the case 30, which face in opposite directions from each other, so as to secure the cables 20. The lanced pieces 38 are rolled inward as illustrated in FIG. 12, thereby having a structure that can have improved shielding properties.

Other portions are similar to those in the connector device 100 in the first embodiment; therefore, the same components are denoted by the same reference numerals. In a similar manner to the first embodiment, the connector device 100S in the second embodiment includes the connector body 10, which has e first and second end surfaces 10T₁ and 10T₂, which face in opposite directions from each other; the cables 20 connected to the connector body 10; and the case 30, which has a back shell structure and houses the connection region where the connector body 10 and the cables 20 are connected. In a similar manner to the first embodiment, the cables 20 may be secured at the end surface of the case 30 by a lanced piece (not illustrated) and be shielded.

With the configuration described above, in addition to the configuration of the connector device 100 in the first embodiment, the connector device 100S in the second embodiment includes, in each of the case body 31 and the case lid 32, the two lanced pieces 38, which are cut and raised inward from the notches 37 formed in each of the case body 31 and the case lid 32. The lanced pieces 38 press against the cables 20 from the first and second main surfaces 30A and 30B of the case 30, which face in opposite directions from each other, so as to secure the cables 20. The lanced pieces 38 are rolled inward as illustrated in FIG. 13. Consequently, the connector device 100S has a structure that prevents noise from reaching the connection region and thus improves the shielding properties. Therefore, with the configuration described above, in addition to the effect of the connector device 100 in the first embodiment, the connector device 100S in the second embodiment can obtain an effect where the EMC performance can be improved without using any electromagnetic interference prevention member and without increasing the number of components.

In a similar manner to the connector device 100 in the first embodiment, the electromagnetic interference prevention member 33, 34, and 35 can also be used in combination, which results in the EMC performance being improved.

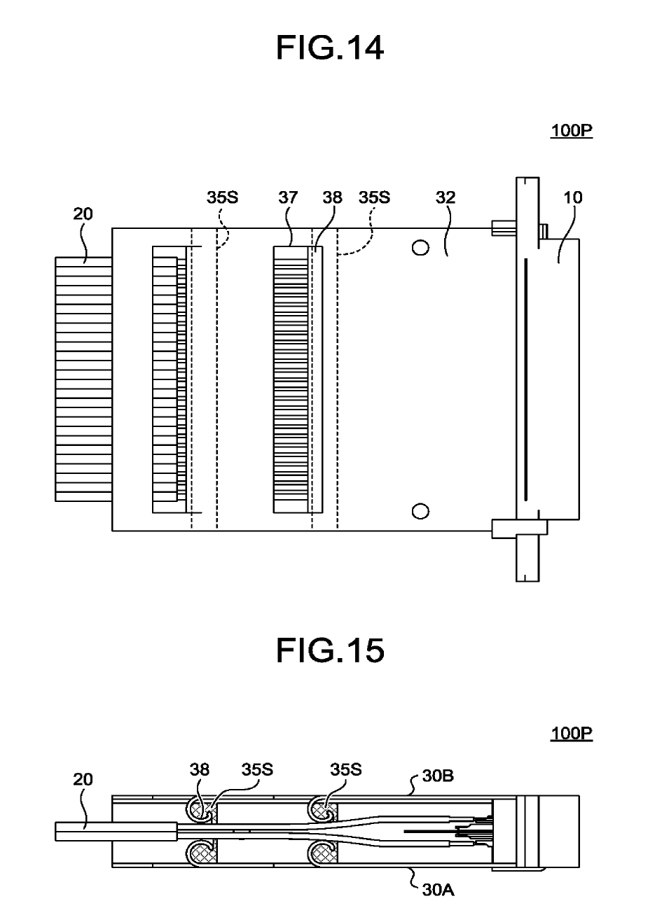

FIG. 14 is a top view illustrating a connector device 100P, which is a modification of the connector device in the second embodiment. As illustrated in the side view with partial cutaway of the connector device 100P in FIG. 15, a cable lead-out portion may be sealed in such a manner that electromagnetic interference prevention members 35S are sandwiched between the lanced pieces 38.

With the above configuration, the connector device 100P in the modification can have improved EMC performance compared to the connector device 100S in the second embodiment.

In the connector device 100S in the second embodiment and the connector device 100P in the modification, the lanced pieces 38 are rolled on the outer side of the electrical connection region where the connector body 10 and the cables 20 are electrically connected, and the lanced pieces 38, which are cut and raised from the case body and the lid, press against the cables 20 from both sides of the case 30. With the above configuration, in addition to the effect of the connector device 100 in the first embodiment, the EMC performance is further improved. In the connector device 100P in the modification, the lanced pieces 38 press against the cables 20 and moreover, the solder layers 17 are poured between the lanced pieces 38 and the cables 20; therefore, an improved sealing structure is obtained in addition to a reliable connection. Moreover, because the electrical connection region is sealed by a conductive member, the magnetic shielding properties are further improved and thus the EMC performance becomes extremely high.

Furthermore, the case body 31 and the case lid 32 are made of elastic bodies, and they have a structure that can have improved shielding properties on the opening side of the case due to the lanced pieces (not illustrated).

### Third Embodiment

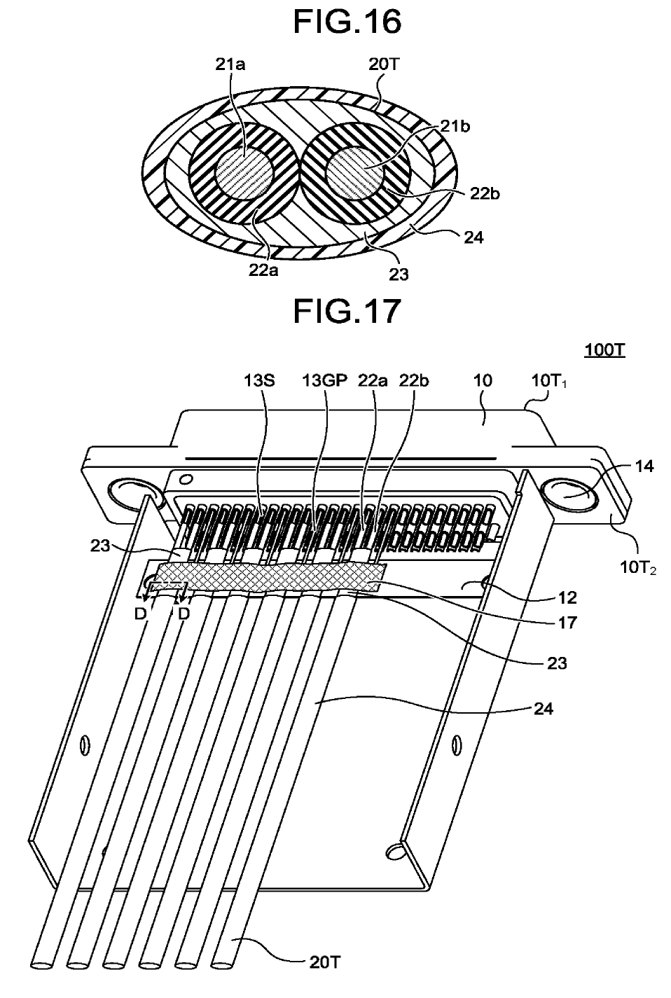

Next, a connector device according to a third embodiment will be described. A description has been given in the first embodiment of a case where the cables 20 are coaxial cables. In the third embodiment, a description will be given of a case where cables 20T are shielded twisted cables. FIG. 16 is a cross-sectional view illustrating a shielded twisted cable, and FIG. 17 is a diagram illustrating connection portions of the connector body 10 and the cables 20T. FIG. 16 is a diagram corresponding to the cross section taken along line D-D in FIG. 17.

A connector device 100T in the third embodiment is different from the first embodiment in the following two points. That is, as illustrated in the enlarged cross-sectional view in FIG. 16, the cable 20T is a twisted pair cable having what is called a twisted pair structure in which two core wires 21a and 21b are sheathed with inner jackets 22a and respectively, and the inner jackets 22a and 22b are in turn sheathed with the ground mesh 23, with the outermost layer being in turn sheathed with the outer jacket 24. Moreover, the structure of the connection between the ground plate 12 and the ground contacts 13G is different due to a twisted pair cable being used.

As illustrated in FIG. 17, in the connector device 100T in the third embodiment, ground contact pins 13GP, which are ground contacts of the connector body 10, are placed on the ground plate 12; the ground plate 12 is interposed between the ground contact pins 13GP and the ground meshes 23 of the twisted pair cables 20T; and the ground contact pins 13GP are connected to the ground meshes 23 by the solder layers 17. The core wires 21a and 21b are connected to the signal line contacts 130. The thin ground contact pins 13GP are connected to the ground plate 12 by the solder layers 17.

Other portions are similar to those in the connector device 100 in the first embodiment; therefore, the same components are denoted by the same reference numerals. In a similar manner to the first embodiment, the connector device 100T in the third embodiment includes the connector body 10, which has the first and second end surfaces 10T₁ and 10T₂, which face in opposite directions from each other; the cables 20T connected to the connector body 10; and the case 30, which has a back shell structure and houses the connection region where the connector body 10 and the cables 20T are connected.

In the connector device 100T in the third embodiment, with the above configuration, even when the cables 20T, which are twisted pair cables, are connected to the connector body 10, the cables 20T can still be mounted with a compact structure. Moreover, the cables 20T can be connected to the connector body 10 without significantly changing the distance between the grounds and the core wires of the cables 20T, which are twisted pair cables. Furthermore, in addition to the effect of the connector device 100 in the first embodiment, because the ground contact pins 13GP of the connector body 10 and the ground meshes 23 of the twisted pair cables are connected with excellent electrical connectivity by interposing the ground plate 12 therebetween, the ground contact pins 13GP, the ground meshes 23, and e ground plate 12 can more reliably be brought into contact with and pressed against each other and the solder layers 17 are poured between the ground contact pins 13GP, the ground meshes 23, and the ground plate 12. Consequently, it is possible to obtain an excellent sealing structure in addition to a reliable connection. Because the cables 201 are sealed by a conductive member, the magnetic shielding properties are high and the magnetic interference prevention effect is high.

The following configuration is also effective. In this configuration, the ground plate 12 is made of a thin conductive body having flexibility, such as metal and the ground plate 12 is interposed between the ground contact pins 13GP and the ground meshes 23, which are shielded wires of the cables 20T, thereby sealing the second end surface 10T₂ side of the base 11.

Moreover, the following configuration is also effective. In this configuration, the ground plate 12 is made of a conductive elastic body and the ground plate 12 is interposed between the ground contact pins 13GP and the ground meshes 23, which are external conductors that are to be the grounds, and the ground plate 12 is elastically deformed so as to have irregularities, thereby sealing the second end surface 10T₂ side of the base 11.

The connector device 100T in the third embodiment can inhibit interference with the signal line contacts 13S by using the ground contact pins 13GP extending to a portion on the ground plate 12; therefore, a given contact can be assigned as a ground contact.

### Fourth Embodiment

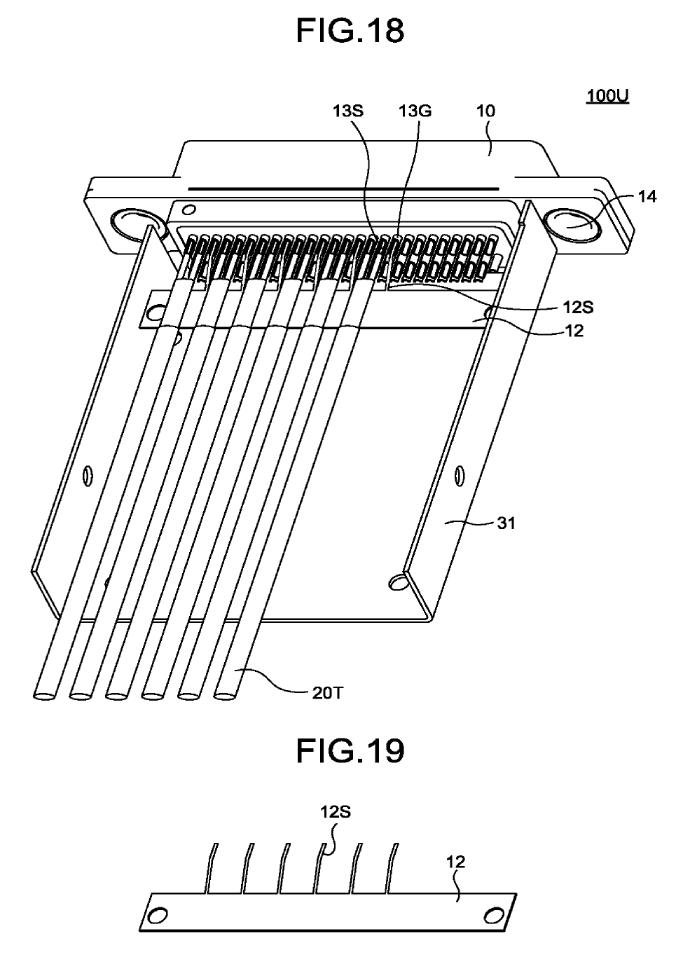

FIG. 18 is an explanatory diagram of the inside of a connector device according to a fourth embodiment. FIG. 19 is an explanatory diagram of a ground plate of the connector device according to the fourth embodiment.

A connector device 100U in the fourth embodiment is different from the connector device 100T in the third embodiment in that the ground plate 12 has a comb-shaped structure. As illustrated in FIG. 19, in the ground plate 12 in the present embodiment, a comb-tooth-like projection 12S is disposed between each of the cables and the connection portion with the ground contact 13G and the connection portions with the signal line contacts 13S are alternately arranged.

With the ground plate provided with the comb-tooth-like projections 12S in the connector device 100U in the fourth embodiment, the ground contacts 13G can be connected at positions that are aligned with the signal line contacts 13S. Consequently, a given contact can be assigned as a ground contact. The ground plate 12 is formed as a comb-shaped body including the projections 125 that are formed intermittently. Signal lines sheathed with inner jackets are arranged between the projections 12S. The projections 12S are not necessarily arranged between each of the cables and the tip positions of the projections 12S can also be selected as appropriate. Ground plates of various types, in which the tip positions and the formation positions of the comb-tooth-like projection 12S are different, can be prepared in advance, and a ground plate in which the comb-tooth-like projections 12S are formed to correspond to the positions of the contacts assigned as the ground contacts can be used.

In the connector device 100U in the fourth embodiment also, the case body 31 and the case lid 32 are made from elastic leaf springs and they are each provided with two lanced pieces 38, which are cut and raised inward. The lanced pieces 38 press against the cables 20T from the sides of the first and second end surfaces, which face in opposite directions from each other, so as to secure the cables 20T, and the lanced pieces 38 are rolled inward as illustrated in FIG. 12, thereby having a structure that can have improved shielding properties. In FIG. 18, the case lid is omitted so that the inside of the case body 31 is visible.

The configuration of the case body 31 and the case lid 32 may be as same as that in any of the first and second embodiments and it can be appropriately changed.

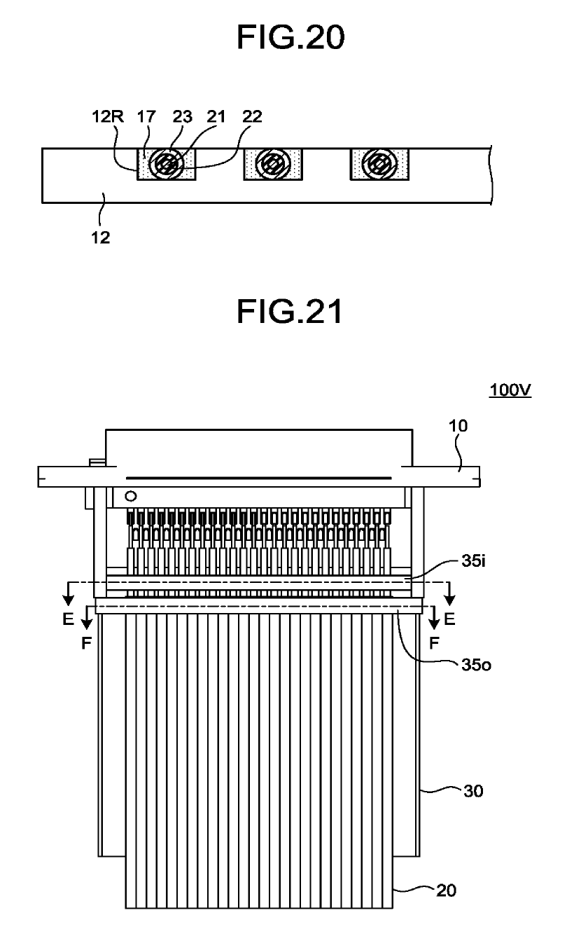

As a modification of the ground plate 12 of the connector device 100U in the fourth embodiment, which illustrated in the cross-sectional view in FIG. 20, recesses 12R may be formed on the ground plate 12 to correspond to the core wires 21 of the cables 20 and the solder layers 17 may be poured into the recesses 12R so as to secure the core wires 21 in place. Consequently, irregularities on the surface of the connection portions can be eliminated. In the modification, the sealing properties are excellent. Moreover, from the point of view of the magnetic interference prevention effect, it is possible to obtain a connector device with high merchantability.

### Fifth Embodiment

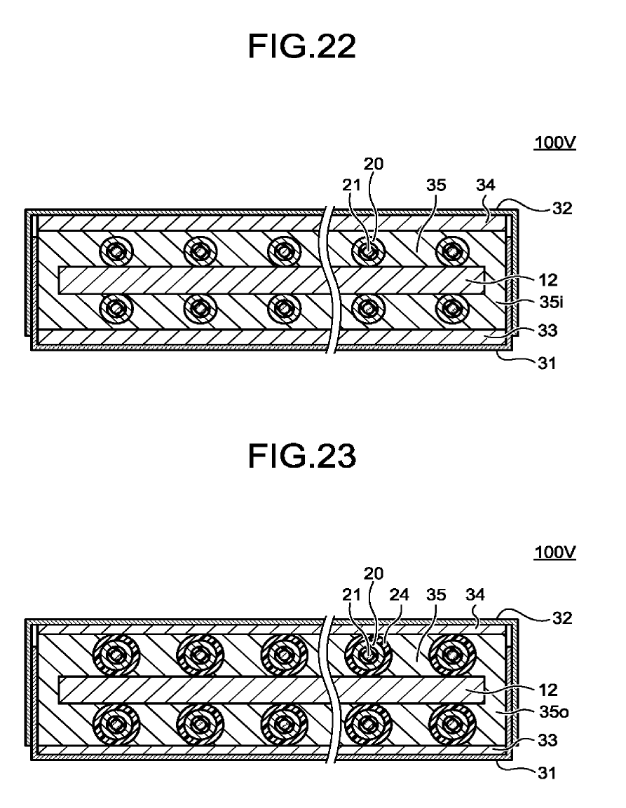

FIG. 21 is an explanatory diagram of the inside of a connector device according to a fifth embodiment, and FIG. 22 and FIG. 23 are explanatory cross-sectional views of the connector device according to the fifth embodiment and correspond to cross sections taken along lines E-E and F-F in FIG. 21. A connector device 100V in the fifth embodiment is configured such that the connection portions of the cables 20 and the connector body 10 and the portion outside the connection portions are sealed with two electromagnetic interference prevention members 35i and 35o.

The fifth embodiment has characteristics such that the strip-shaped inner-side electromagnetic interference prevention member 35i seals the space in the case 30 by confining the cables 20 in the portion in which the cables 20 are stripped of the outer jackets 24 and the cables 20 are connected to the ground plate 12 and the strip-shaped outer-side electromagnetic interference prevention member 35o seals the space in the case 30 by confining the outer jackets 24 of the cables 20 on the outer side of the electromagnetic interference prevention member 351. Other portions are similar to those in the first embodiment.

In the fifth embodiment, with the above configuration, it is possible to obtain a connector device having a higher EMC performance than that of the connector device 100 in the first embodiment.

### Sixth Embodiment

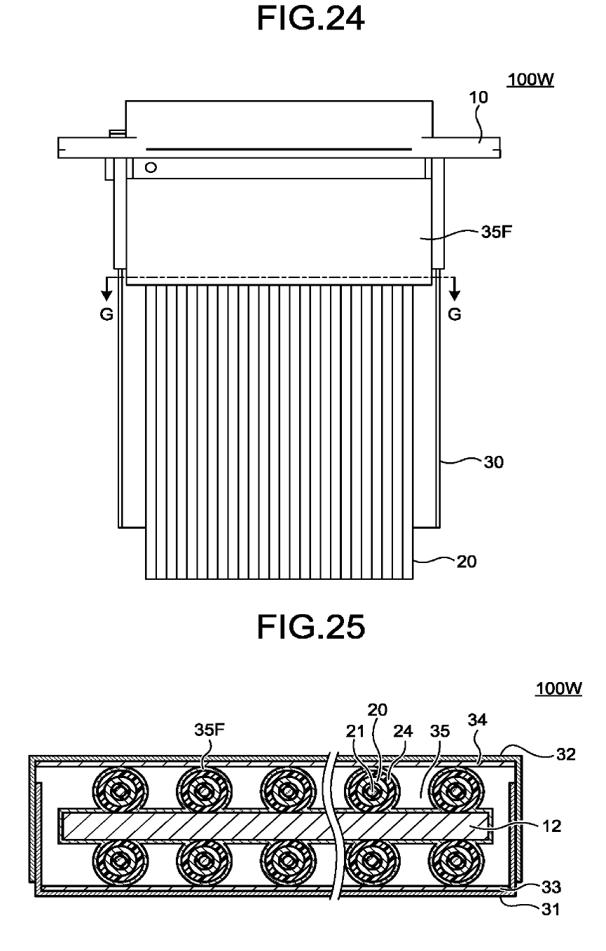

FIG. 24 is an explanatory diagram of the inside of a connector device according to a sixth embodiment, and FIG. 25 is an explanatory cross-sectional view of the connector device in the sixth embodiment and corresponds to a cross section taken along line G-G in FIG. 24. In the fifth embodiment, the connection portions of the cables 20 and the connector body 10 and the portion outside the connection portions are sealed by the two electromagnetic interference prevention members 35i and 35o. In a connector device 100W in the sixth embodiment, a foil-like electromagnetic interference prevention sheet 35F is brought into close contact with the connection portions.

In the sixth embodiment, the thin foil-like electromagnetic interference prevention sheet 35F is placed on the connection portions and is brought into close contact with the connection portions by exhausting the internal air therebetween, whereby the foil-like electromagnetic interference prevention sheet 35F is mounted.

With the above configuration, the connector device can be reduced in size and weight; therefore, it possible to obtain the connector device 100W having an excellent EMC performance.

The ground plate made of a flexible conductor may have a shape such that it is interposed between the ground contacts and the ground meshes of the cables and it seals the space on the second end surface side of the base.

The cables are not limited to coaxial cables and shielded twisted pair cables described in the above embodiments, and cables of various other types, such as pair cables and twisted pair cables, can also be used.

Moreover, for example, any replacement or combination of the electromagnetic interference prevention members in the above embodiments can be made as appropriate in accordance with the need. It is possible to use various types of conductive materials for the electromagnetic interference prevention members, and these materials include metal mesh, metal foil, conductive foil, and conductive resin.

Furthermore, although the contacts in the second and third rows are used as the ground contacts in the first embodiment, the contacts in the second and third rows may be unified and drawn out. Moreover, the number of external contacts of the ground contacts may not necessarily match the number of cables, and some external contacts may be unified.

In the first to sixth embodiments, the contacts 13 and the cables 20 are connected by solder; however, using solder is not a limitation. In addition t various solders, such as a low-temperature solder, it is possible to use a bonding method that uses a conductive adhesive, such as a silver paste, and a bonding method such as ultrasonic welding. When a solder connection is made by using a older bonding method, members can be bonded at the same time by forming, in advance, a solder layer on one side of a component to which the members are to be bonded, such as by plating the surface of the ground plate 12 with colder, and then performing a thermal treatment. Moreover, it is possible to use a method of applying an appropriate amount of solder to each location by using a solder supply nozzle and then performing a thermal treatment.

In the first to sixth embodiments, a multipole connector means the connector body 10 including the ground plate 12 and the connector device means the connector body 10 equipped with the cables 20 or 20T and the case 30.

The configurations illustrated in the above embodiments are examples of the content of the present invention and can be combined with other publicly known technologies, and part of each of the configurations can be omitted or modified without departing from the gist of the present invention.

### REFERENCE SIGNS LIST

10 connector body, 11 base, 12 ground plate, 12R recess, 12S projection, 13 contact, 13S signal line contact, 13G ground contact, 13GP ground contact pin, 14 mounting hole, 15 terminal tube, 16 external contact, 20, 20T cable, 21 core wire, 22 inner jacket, 23 ground mesh, 24 outer jacket, 30 case, 31 case body, 32 case lid, 32h mounting hole, 33, 34, 35, 35i, 35o electromagnetic interference prevention member, 35F electromagnetic interference prevention sheet, 36 screw, 37 notch, 38 lanced piece, 100, 100S, 100P, 100T, 100U, 100V, 100W connector device, R₁ first region, R₂ second region, R₃ third region.

1. A multipole connector comprising:
a connector body that includes a first end surface and a second end surface;
a plurality of contacts that are arranged and led to the first end surface of the connector body; and
a ground plate arranged on the second end surface side of the connector body, wherein
the multipole connector is connected to a cable in which external conductors that are to be grounds and core wires that are to be signal lines are insulated from each other by an inner jacket and an outer side is sheathed with an outer jacket,
the signal lines are connected to the contacts, respectively,
the external conductors are connected together on the ground plate, and
the ground plate is connected to at least one of the contacts.

2. The multipole connector according to claim 1, wherein
the connector body includes
an insulating base in which the contacts that are made from a conductor and are arranged in a plurality of rows are embedded,
signal line contacts that are exposed to the first end surface and the second end surface, extend from the second end surface, and are connected to the signal lines, and
ground contacts that are exposed to the first end surface and the second end surface, extend from the second end surface, and are connected to the ground plate.

3. The multipole connector according to claim 1, wherein
the contacts include ground contacts arranged to face the external conductors on the ground plate, and
the external conductors and the ground contacts are connected to the ground plate by soldering.

4. The multipole connector according to claim 3, wherein the ground contacts extend between the signal lines that are sheathed with the inner jacket and are adjacent to each other to reach a portion on the ground plate, and the ground contacts are connected to the ground plate.

5. The multipole connector according to claim 3, wherein
the ground plate is formed as a comb-shaped body including projections that are formed intermittently, and
the signal line sheathed with the inner jacket is arranged between the projections.

6. The multipole connector according to claim 3, wherein
the ground plate includes, in accordance with an arrangement of the cables, recesses that match a diameter of the cables on a first main surface that is orthogonal to the second end surface of the connector body, and
the external conductors are placed in the recesses and a solder is inserted into the recesses.

7. The multipole connector according to claim 1, wherein the external conductors are connected to both surfaces of the ground plate.

8. The multipole connector according to claim 1, further comprising an electromagnetic interference prevention member on an outer side of a contact region where the ground plate, the external conductors, and ground contacts are connected, the electromagnetic interference prevention member sealing the contact region.

9. The multipole connector according to claim 1, further comprising an outer conductor on an outer side of a contact region where the ground plate, the external conductors, and ground contacts are connected, the outer conductor being in close contact with and covering the contact region.

10. A connector device comprising:
a connector body that includes a first end surface and a second end surface;
a plurality of contacts that are arranged and led to the first end surface of the connector body;
a ground plate arranged on the second end surface side of the connector body;
a plurality of cables in each of which an external conductor that is to be a ground and a core wire that is to be a signal line are insulated from each other by an inner jacket and an outer side is sheathed with an outer jacket; and
a case that houses a contact region where the ground plate, the contacts, and tips of the cables are connected, wherein
in the contact region, the signal lines are connected to the contacts, respectively, the external conductors are connected together on the ground plate, and the ground plate is connected to at least one of the contacts.

11. The connector device according to claim 10, wherein
the connector body includes
an insulating base in which the contacts that are made from a conductor and are arranged in a plurality of rows are embedded,
signal line contacts that are exposed to the first end surface and the second end surface, extend from the second end surface, and are connected to the signal lines, and
ground contacts that are exposed to the first end surface and the second end surface, extend from the second end surface, and are connected to the ground plate.

12. The connector device according to claim 10, wherein
the contacts include ground contacts arranged to face the external conductors on the ground plate, and
the external conductors and the ground contacts are connected to the ground plate by soldering.

13. The connector device according to claim 12, wherein the ground contacts extend between the signal lines that are sheathed with the inner jacket and are adjacent to each other to reach a portion on the ground plate, and the ground contacts are connected to the ground plate.

14. The connector device according to claim 12, wherein
the ground plate is formed as a comb-shaped body including projections that are formed intermittently, and
the signal line sheathed with the inner jacket is arranged between the projections.

15. The connector device according to claim 12, wherein
the ground plate includes, in accordance with an arrangement of the cables, recesses that match the cables on a first main surface that is orthogonal to the second end surface of the connector body, and
the external conductors are placed in the recesses and a solder is inserted into the recesses.

16. The connector device according to claim 10, wherein the external conductors are connected to both surfaces of the ground plate.

17. The connector device according to claim 10, further comprising an electromagnetic interference prevention member on an outer side of a contact region where the ground plate, the external conductors, and ground contacts are connected, the electromagnetic interference prevention member sealing the contact region.

18. The connector device according to claim 10, further comprising an outer conductor on an outer side of a contact region where the ground plate, the external conductors, and ground contacts are connected, the outer conductor being in close contact with and covering the contact region.

19. A case comprising:
a case body made from a conductive plate having a C-shaped cross-section; and
a case lid that fits the case body, wherein
a plurality of cables, in each of which an external conductor that is to be a ground and a core wire that is to be a signal line are insulated from each other by an inner jacket and an outer side is sheathed with an outer jacket, are connected to a multipole connector,
the multipole connector includes
a connector body that includes a first end surface and a second end surface,
a plurality of contacts that are arranged and led to the first end surface of the connector body, and
a ground plate arranged on the second end surface side of the connector body,
a contact region is provided, in which the signal lines are connected to the contacts, respectively, the external conductors are connected together on the ground plate, and the ground plate is connected to at least one of the contacts, and
the case houses the contact region where the ground plate, the contacts, and tips of the cables are connected.

20. A method for connecting a cable to a multipole connector, the method comprising:
forming a connection portion in a multipole connector, which includes a connector body that includes a first end surface and a second end surface, a plurality of contacts that are arranged and led to the first end surface of the connector body, and a ground plate arranged on the second end surface side of the connector body, by stripping an outer jacket of a plurality of cables by a constant distance from a tip of the cables, each of the cables being configured such that an external conductor that is to be a ground and a core wire that is to be a signal line to be connected to one of the contacts are insulated from each other by an inner jacket and an outer side is sheathed with the outer jacket, by positioning the cables such that a first region, in which the external conductor is exposed, is located over the ground plate, the second region, which corresponds to a tip of a ground contact of the contacts, faces the first region on the ground plate, and the third region, which corresponds to a tip of a signal line contact of the contacts, is in contact with the signal line, and by soldering the cables to the multiple connector at a same time; and
securing the cables such that the connection portion is covered with a case body, a case lid, and an electromagnetic interference prevention member.
